(19) United States
(12) Patent Application Publication
(10) Pub. No.: US 2016/0086449 A1
(43) Pub. Date: Mar. 24, 2016

(54) BLACKJACK GAME WITH PROGRESSIVE SIDE WAGER

(71) Applicant: DEQ Systems Corp., Levis (CA)

(72) Inventors: Marcel Huard, Levis (CA); Michel Bolduc, Levis (CA)

(21) Appl. No.: 14/862,001

(22) Filed: Sep. 22, 2015

Related U.S. Application Data
(60) Provisional application No. 62/053,777, filed on Sep. 22, 2014.

(51) Int. Cl. G07F 17/32

(52) U.S. Cl. CPC G07F 17/3258; G07F 17/3293; G07F 17/322

(57) ABSTRACT

Systems and methods of presenting a game and a progressive jackpot. At least one deck of playing cards are provided at a gaming device equipped with the progressive controller. A progressive wager is accepted from a player qualifying the player to participate in a progressive. A base game of blackjack is presented including dealing cards to form a player hand and a house hand. The outcome of the first blackjack game is determined and winnings are paid or bets are collected according to blackjack rules. It is also determined if the first dealt player card of the player hand has a rank of two. When the first dealt player card has the rank of two, a number of consecutive two-ranked cards in the player hand is determined. The number of consecutive two-ranked cards is compared to a pay table defining a progressive jackpot award for the consecutive two-ranked cards.

### PRIORITY CLAIM

This application claims priority to and the benefit of U.S. Provisional Patent Application 62/053,777 filed on Sep. 22, 2014.

### BACKGROUND

1. Field of the Invention

The disclosed embodiments relate to wagering games, side wagering games, and a progressive jackpot system.

2. Related Art.

In order to increase revenue at a gaming table or at a gaming machine, gaming companies have looked to add side wagers in addition to the base game such that the side wager qualifies a player to participate in a secondary game for a secondary award. The intent is that the side wager will allow additional wagers above and beyond those placed in a base game in order to increase revenue. In addition, the chance of winning the potentially large award will encourage a player to play the base game as well as the secondary game, which also increases revenue.

However, existing side wagers and secondary games suffer from several disadvantages. One such disadvantage is that side wagers often slow down the rate of play of the base game. When the rate of play of the base game decreases, the total overall revenue may decrease at a particular gaming table or machine, despite the addition of the side wager. This is because the number of plays per hour of the base game may decrease due to the presence of the side wager.

Further, side wagers may also cause players of a base game to abandon the typical game strategy of the base game. For example, in a game a blackjack, a player who would typically “stand” as the best strategy for the blackjack game may instead take additional cards for the purpose of the side wager, despite the fact that this may increase the player's chances of busting. Further, other players on a game table may feel that the player who has taken the additional cards against the typical base game strategy has “ruined” the next player's hand.

The following disclosed gaming machine and method of operation of the gaming machine overcomes the drawbacks of the prior art and provides additional benefits.

### SUMMARY

According to one exemplary embodiment, method of presenting a game at a gaming table equipped with or communicating with a progressive controller and one or more wager detectors is provided. At least one physical deck of at least 52 playing cards is provided at the playing table equipped or communicating with the progressive controller. Additional sets or decks of gaming cards may be provided. A first wager from a player is accepted to allow the player to participate in a blackjack game.

A second wager is accepted (or a portion of the first wager is allocated) from the player qualifying the player to participate in a secondary game. The second wager may be detected with the one or more wager detectors. The wager detector may generate a second wager signal which is received by the progressive controller. The progressive controller may increment a progressive jackpot by an amount of the second wager, or by a portion of the amount of the second wager. The incremented progressive jackpot amount may be displayed on a progressive display. Use of a progressive with the game is optional.

The blackjack game is presented including dealing cards to form a player hand and a house hand. The player hand includes a first dealt player card and one or more subsequently dealt player cards that are dealt to the player after the first dealt player card. An outcome of the first blackjack game is determined according to conventional rules. When the outcome of the Blackjack game is a winning outcome, a blackjack game award is awarded to the player.

The method determines if the first dealt player card of the player hand has a rank of two. When the first dealt player card has the rank of two, a number of consecutive subsequently dealt player cards that also have the rank of two is determined. Based on this, a number of consecutive two-ranked cards is identified.

The number of consecutive two-ranked cards is compared to a pay table. The pay table may define a standard award or a progressive jackpot award amount based on the number of consecutive two-ranked cards. Responsive to the comparison, a payout is provided from the progressive jackpot to the player, or the award may be based on a paytable.

According to some embodiments, a maximum number of consecutive two-ranked cards is six. In another configuration more than six of the same rank of cards must be received to qualify the player for the maximum award. In other embodiments, the entire progressive jackpot is paid when the number of consecutive two-ranked cards is six. A portion of the progressive jackpot, but not all, may be paid when the number of consecutive two-ranked cards is between 1 and 5. According to an exemplary embodiment, the number of consecutive two-ranked cards does not change a player strategy in the blackjack game of receiving subsequently dealt player cards.

According to other exemplary embodiments, a method of presenting a progressive jackpot to players at one or more gaming tables is provided. At least one physical deck of playing cards is provided at the one or more gaming tables. The one or more gaming tables may be communicatively coupled to a progressive jackpot controller. A first wager from a player to participate in a base wagering game is accepted at the one or more gaming tables.

A second wager from the player is accepted (or a portion of the first wager allocated) qualifying the player to receive a secondary award, such as from a paytable or a portion of or all off a progressive jackpot. The second wager may be detected with the one or more wager detectors that are located overhead, in the table, part of the table, or by a dealer. The wager detector may generate a second wager signal that is received at the progressive jackpot controller. The progressive jackpot controller may increment a progressive jackpot by an amount of the second wager or by a portion of the amount of the first wager. The incremented progressive jackpot amount may be displayed on a progressive display.

The base wagering game may be presented which may include dealing the playing cards to form a hand of cards. The hand may include a first dealt card and one or more subsequently dealt cards that are dealt after the first dealt card. An outcome of the base wagering game is determined, and when the outcome of the base wagering game is a winning outcome, a game award is awarded to the player.

The method further comprises determining if the first dealt card has a predetermined rank, and when the first dealt player card has the predetermined rank, determining a number of consecutive subsequently dealt cards conforming to one or more predetermined winning patterns. The subsequently dealt cards conforming to one or more predetermined winning patterns are compared to a pay table. The pay table may define a progressive jackpot award amount based on the one or more predetermined winning patterns. Responsive to the comparison, a payout from the progressive jackpot is awarded to the player.

In some embodiments, the predetermined winning patterns do not alter a strategy for receiving the subsequently dealt cards in the base wagering game. The base wagering game may be a blackjack game. The one or more predetermined winning patterns may comprise one or more winning cards in which a sum of the rank of the one or more winning cards included in the one or more predetermined winning patterns excluding one winning card is less than or equal to ten.

For example, the one or more predetermined winning patterns may comprise consecutive cards having a rank of two, and a maximum number of the consecutive cards having the rank of two is six. The consecutive cards having a rank of two may require that the first card dealt be a two. In another example, the one or more predetermined winning patterns comprise consecutive cards having a rank of three, and a maximum number of the consecutive cards having the rank of three is four. In yet another example, the one or more predetermined winning patterns comprise consecutive cards having a rank of four, and a maximum number of the consecutive cards having the rank of four is three. In addition to cards of the same number, the one or more predetermined winning patterns may comprise consecutive cards comprising a straight with a lowest ranked card of two, and a longest straight being consecutive cards comprising the ranks of two, three, four, and five. In some embodiments, the comparing of the cards in the hand to the pay table is continually performed during the presenting of the base wagering game. Card values other than two may be designated as the required card rank. For example a three value card or a particular face card may be required.

In another exemplary embodiment, a system for presenting an award to a player is provided. The system may include a progressive jackpot controller comprising a processor and at least one memory storing machine readable instructions, a progressive jackpot display communicatively coupled to the progressive jackpot controller, and at least one gaming device. The gaming device may comprise at least one wagering accepting device that accepts a wager from a player participating in the progressive jackpot. The at least one gaming device being may present a base wagering game separate from the progressive jackpot, and may be communicatively coupled to the progressive jackpot controller;

The at least one gaming device may provide for at least one deck of playing cards to present the base wagering game and the progressive jackpot. The wagering accepting device may accept a first wager from a player to participate in a base wagering game at the gaming device and may accept a second wager from the player qualifying the player to participate in the progressive jackpot.

The progressive jackpot controller may receive a second wager signal generated by the wagering accepting device and may increment the progressive jackpot by an amount of the second wager or by a portion of the amount of the first wager. The progressive jackpot display may show an incremented progressive jackpot amount.

A base wagering game may be presented via the gaming device. The base wagering game may include dealing the playing cards to form a hand of cards. The hand may include a first dealt card and one or more subsequently dealt cards that are dealt after the first dealt card. The gaming device may send identification information for the first dealt card and the subsequently dealt cards to the progressive jackpot controller.

The progressive jackpot controller may determine if the first dealt card has a predetermined rank. When the first dealt player card has the predetermined rank, the progressive jackpot controller may determine a number of consecutive subsequently dealt cards conforming to one or more predetermined winning patterns.

The progressive jackpot controller may compare the subsequently dealt cards conforming to one or more predetermined winning patterns to a pay table. The pay table may define a progressive jackpot award amount based on the one or more predetermined winning patterns. Responsive to the comparison, the progressive jackpot controller may provide a payout from the progressive jackpot to the player.

In some embodiments, the at least one gaming device comprises one or more gaming tables. In further embodiments, the at least one gaming device comprises one or more video gaming machines. The base wagering game may be the game of blackjack. The predetermined winning patterns may be such that they do not alter a strategy for receiving the subsequently dealt cards in the base wagering game.

The wager accepting device may include one of an RFID detector and an optical detector. The hand of cards may be at least one of a player hand and a dealer hand.

Also disclosed is a method of presenting a game at a gaming table using (providing) at least one physical deck of at least 52 playing cards at the physical game table. The method includes accepting a first wager from a player to participate in a blackjack game, and accepting a second wager from the player such that the second wager qualifying the player to participate in a secondary game. This method of play then presents the blackjack game to the player including dealing cards to form a player hand and a house hand, the player hand including a first dealt player card and one or more subsequently dealt player cards that are dealt to the player after the first dealt player card. This method then determines an outcome of the blackjack game and when the outcome of the blackjack game is a winning outcome, awarding a blackjack game award to the player.

As part of the second wager aspect of the game, the method of operation then determines if the first dealt player card has a predetermined characteristic and when the first dealt player card has the predetermined characteristic, determining a number of consecutive subsequently dealt player cards that have the subsequent card predetermined characteristics to determine a second game outcome. Then, comparing the second game outcome to a paytable, such that the paytable defines an award amount or an award percentage for winning second game outcomes. Finally, responsive to the comparison, providing a payout to the player when the second game outcome is a winning second game outcome. The payout may be based on a paytable or a portion of or all of a progressive jackpot.

In one embodiment, the predetermined characteristic is a rank of 2 or a pair of cards. In one configuration, the predetermined characteristic for the first dealt player card may is not the same as the predetermined characteristics for subsequently dealt player cards.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 illustrates an exemplary gaming table with a progressive controller, according to one embodiment.

FIG. 2 illustrates a method of playing a base game with a side wager, according to one embodiment.

FIG. 3 illustrates an exemplary gaming machine according to one embodiment.

FIG. 4 illustrates an exemplary gaming machine network with associated gaming server and associated progressive controller.

### DETAILED DESCRIPTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise methods of playing and presenting games. Other embodiments of the invention comprise systems and/or devices for presenting games.

One embodiment of the invention comprises a game which has a side wager. In a preferred embodiment of the invention, the game is a Blackjack game, wherein one or more players may make a side wager on specific outcomes that may occur during the underlying base game, such as obtaining certain cards in a dealer's or player's blackjack hand.

The Blackjack game may be presented in various fashions, as is well known in the art. In particular, a number of variations of Blackjack games are known. Some examples of Blackjack games are described below.

In one embodiment, games according to the disclosed embodiments are preferably presented as wager-based games. As such, the player may be required to place a wager, bet, or ante in order to play the Blackjack game. The amount of the wager may vary, and in one embodiment may be no less than a predefined minimum amount such as $0.10 or $0.25, or as much as $1, $5, or greater. The wager might be placed as moneys, points, credits having monetary value, or the like.

Once the player has placed any required wager, two cards are dealt to the player. The cards may be dealt in a variety of manners. In the case of a gaming machine, the cards may be generated via random selection, such as through a random number generator, and displayed as video images. In the case of a table, the cards may be dealt randomly from a deck or set of physical playing cards, such as from a card shoe. The cards dealt to each player may be dealt face up, face down, or a combination thereof.

Preferably, two cards are dealt to the dealer or house, one card face up and the other face down. In other embodiments, the dealer's or house's cards may be both dealt face up. Again, the cards might be physical cards or video images of cards or the like. These cards comprise an initial house or dealer hand.

Play may then proceed in a conventional manner, with the player electing a next action. This action may comprise, for example, standing, taking one or more cards or “hits,” making an insurance bet, or determining whether to split pairs, to double down, or surrender.

In one or more embodiments, a player may make an insurance bet if the dealer's face up card is an ace. This bet is generally made after the player's and dealer's cards have been dealt, but before other cards have been dealt. In accordance with this bet, a player may wager an amount, such as one-half of their original wager or ante, as insurance against the dealer having a Blackjack (i.e. two card count of 21). If the dealer has a Blackjack, unless the player also has a Blackjack, the player loses on his original wager or ante, but is paid a winning at 2:1 on his insurance bet. In one embodiment, if the dealer has a Blackjack, the game is over. The player loses on their original wager or ante unless the player also has a Blackjack, in which event a “push” is declared, and those players are refunded their original wager or ante. If the dealer's hand is not a Blackjack, then the player loses their insurance bet and then the game continues.

In one or more embodiments, a player may be permitted to surrender. In particular, in one embodiment of the game, a player may concede their hand, announcing a surrender and forfeiting some of their wager or ante, such as one-half of their wager. In one embodiment, a player is not permitted to surrender in the event the dealer has a Blackjack.

In one or more embodiments, a player may be permitted to “double down.” If the player's first two cards have a predetermined count, such as 9, 10 or 11 (or in other embodiments, only 10 or 11, or only 11) then the player may be permitted to make a second wager equal to their first wager (i.e. double-down). The player is then dealt a single additional card, and the three cards then comprise the player's hand for purposes of determining if the player's hand is a winning hand or losing hand.

In one or more embodiments, a player may be permitted to “split pairs.” If the player's first two cards are a pair, then the player may be permitted to split the pair of cards, with each of the cards of the pair forming one card of each of two separate hands. The player's original wager or bet is applied to one of the hands, and the player is required to place a second wager to play the second hand. The player is dealt a second card for the two split hands, and then the two hands are treated just as single hands during the play of the game. For example, the player may stand or elect to take additional cards for either hand. In one embodiment, a player may be permitted to split a pair of Aces, but the player may be entitled to receive only a single additional card (i.e. to form a two card hand). An exception to this rule may be that if the player receives a second card which is an Ace, the player may be permitted to split the hands again, or may be permitted to receive additional cards for the hand, as desired.

In one embodiment, a player may be permitted to split pairs received on already split hands. For example, if a player splits a pair of Fours into a first hand and a second hand and then receives another Four in relation to either the first hand or second hand, the player may then split that hand, resulting in the player having three hands.

In one embodiment, a player may be permitted to “double down” on a split hand in similar manner to a conventional single hand. For example, if the player splits a pair of Sixes into a first hand and a second hand and then receives a Four with respect to one of the hands, the player may be permitted to double down and receive a single third card to form the three card hand.

With respect to the player's hand (or hands, in the case of splits), the player may also stand or take one or more additional cards or “hits.” If the player is satisfied with their hand, they may elect to stand and not take any additional cards. The determination of whether the player's hand is a winning hand is then made in accordance with the conventional rules of Blackjack detailed below.

A player may also elect to take one or more cards (such as by indicating to a dealer at a table, or via input to a gaming machine). If the player elects to receive additional cards at their turn, the dealer deals the additional cards. If the player's card count exceeds 21 at any time, then the player's hand is a losing hand and the player loses their wager. If the player's card count is less than 21 when they stand (i.e. when they stop taking additional cards) then the determination of whether the player's hand is a winning hand is made in accordance with the conventional rules of Blackjack detailed below.

Generally, the treatment of the house or dealer hand is in accordance with predetermined rules. In accordance with conventional rules, the dealer must generally take additional cards if the dealer's card count is less than 17 (i.e. 16 or less). If upon taking additional cards the dealer's hand exceeds a card count of 21, then the dealer's hand is a losing hand and the player's hand (or hands) is declared a winning hand.

In one embodiment of the game, an exception to the above-stated rule may be that the dealer must take additional cards when the dealer's hand is a “soft” 17. By “soft” it is meant that the dealer has received a card count of 17 comprising an Ace and one or more other cards totaling a count of six.

In accordance with the game, the outcome is determined by comparing the player's hand (or hands) with the dealer's hand after all cards have been dealt. If the player's hand is closer to a card count of 21 than the dealer's, without going over 21, then the player's hand is declared a winning hand. If the count of the player's hand and the dealer's hand are the same, then a “push” is declared. The game is ended for that player and the player's wager is returned.

In one embodiment, if a player's hand is a winning hand and is other than a Blackjack (i.e. other than a two card 21, such as a three or greater card count of 21), then the player may be awarded winnings, such as a payout equal to the player's wager or bet, i.e. at 1:1.

In the event a player's hand is a Blackjack (i.e. a two card hand with a count of 21—i.e. an Ace and any ten value card) and the dealer's hand is a Blackjack, then in a preferred embodiment, a push is declared and the game is over and the player's wager or ante is returned. If the player's hand is a Blackjack and the dealer's hand is not, then the player's hand is a winning Blackjack hand. Preferably, the player is paid or awarded winnings, such as a payout of 1:1, 3:2, 6:5 or 2:1 of the player's wager.

Each Blackjack game may be played with a single standard deck of 52 cards (either physical cards or representations thereof in a gaming machine environment). In other embodiments, the game may be played with multiple decks of cards.

It will be appreciated that a player may be “paid” or awarded winnings in a variety of manners. For example, the player may be awarded chips or other forms of credit, as well as currency. In this regard, the terms “pay” or “paid” and the like are meant to also mean “award.”

Of course, each Blackjack game can be played in various manners, such as with other features than as described above or in other manners. For example, the cards may be dealt in different fashions (such as different combinations of cards dealt face-up, face-down or the like).

Additional aspects of the disclosed embodiments will be described below. As indicated herein, the game may be presented and played using physical playing cards, such as at a physical game table. The table may include a felt or other printed or illustrated layout on a support surface with legs or other means to suspend the table at a height usable by the player and dealer. The table and layout may include a dealer and one or more player positions, as well as card and bet positions. The dealer may be a person or a virtual dealer, such as a simulated person (electronic based) or a mechanical dealer. A method of playing or presenting a game may include use of the table and layout such as, for example, dealing (removing from the deck and moving cards) the cards to the card positions. In such a configuration, the game could be presented to multiple players, such as with bonus events applying to each individual player.

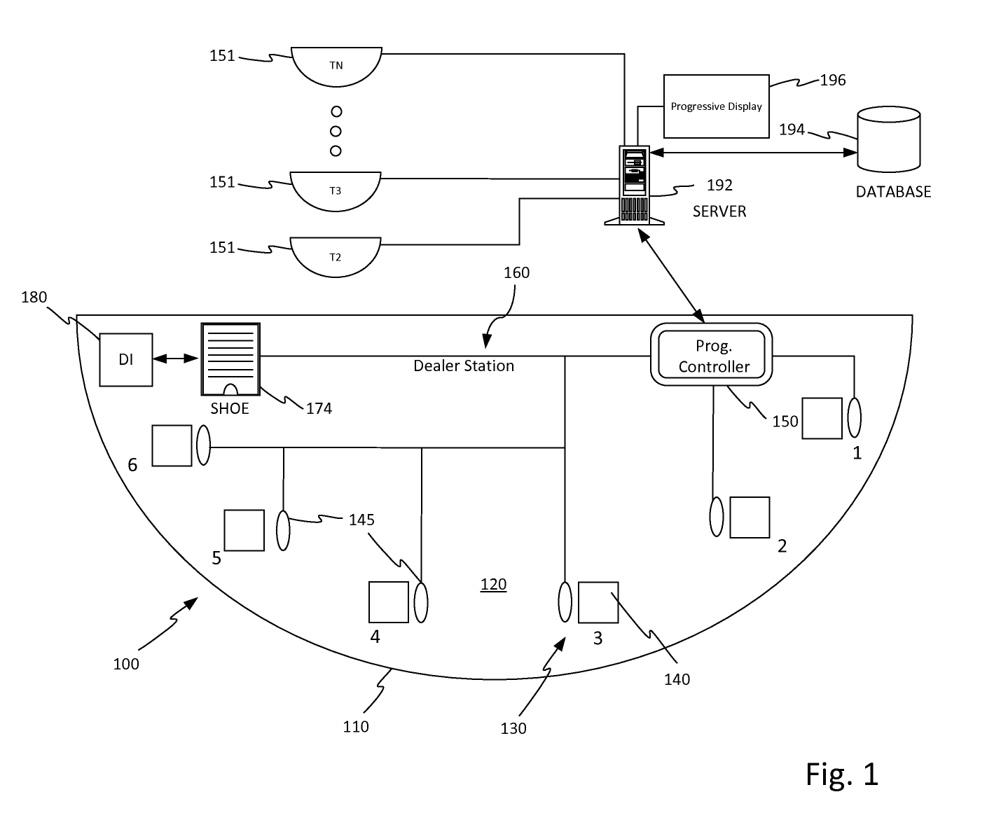

FIG. 1 illustrates a block diagram of an example embodiment of a gaming table 100. This is but one possible table arrangement and layout and it is contemplated that one of ordinary skill in the art may arrive at other table arrangements to promote game play or accommodate a greater or fewer number of players. For example, it is contemplated that the method and apparatus described herein may be utilized with any game layout. Likewise, the table can be configured in a stand-up or sit down arrangement.

In this example embodiment gaming table 100 includes an outer edge 110 surrounding a generally flat top surface 120. The table 100 may also be configured to accommodate other types of traditional table games including, but not limited to, any type of blackjack, poker wherein the house only receives a percentage or rake from the pot of money wagered by the players, baccarat, pai gow, proprietary table games, or non-proprietary card table games which may use any combination of dice, wheels, or cards. Traditional table games include games of chance that use cards or dice, and tokens (also denoted as gaming chips), currency, currency equivalents or credit vouchers which may be of differing values. Of course, any table game may be played in a tournament format. In this discussion, the table is configured for use as a blackjack table.

Traditional table games also include proprietary games such as Caribbean Stud® which include a progressive jackpot. Other proprietary traditional table games include blackjack games such as Monopoly® Blackjack, Progressive Blackjack®, Blackjack Bullets™ and Matrix Blackjack™. Proprietary table games are table games for which a casino will lease or purchase from a manufacturer because the proprietary traditional table game is protected by the intellectual property of the manufacturer. The following description illustrates an exemplary embodiment of the system with reference to playing a blackjack card game. Of course, without limiting the scope of the disclosure, the forms, types, and variations of the game are immaterial to the teachings of the present invention.

As is well known by a person skilled in the art, in a round of playing a blackjack card game, initially a hand comprising two cards may be dealt by a dealer to one or more players and to the dealer. The dealer may distribute cards to the players face-up from one or more decks of cards according to pre-established rules of the game. In other variations of the game, the dealer may deal cards face-down to the players. The dealer is dealt one card face-up and one card face-down (termed the hole card). During play of the game, each player may receive further cards (termed being hit) from the dealer to improve the player's hand. The dealer may discard (or according to the terminology of the art “burn”) one or more cards when dealing the cards to insure security of the game. Additionally, the dealer may discard a hand when a player folds the hand. When all players stand (in other words, cease requesting cards), playing card distribution to the one or more players ceases and the dealer may reveal the dealer's hand. The dealer may further deal cards to the dealer's hand. When no further cards are distributed to the dealer (known in the art as the dealer stands) the players' hands may be compared to the dealer's hand and a settlement may occur between the dealer and each player. The dealer may then dispose of all cards, and begin yet another round of play of the game.

In this example embodiment of a gaming table 100, there is an outer edge 110 of the table. One or more player stations 130 (also denoted herein as player locations) are provided and configured for use by a player to participate in a wagering game or a game of chance offered at the table 100 such as blackjack. In this embodiment the player stations 130 comprise a player position 140 wherein a player is dealt playing cards and a player may accumulate tokens during the course of play. For example, the player may place original gaming chips (or tokens) and tokens that are won within the area of player position 140 during the course of play.

In other embodiments, one or more progressive wager detectors 145 may be located in one or more other locations on the table surface 120 or be a separate device independent from the table 100. The progressive side wager detectors 145 may comprise a coin-in (or token) slot which accepts a coin or token or an RFID or optical detector which detects the side wager or progressive wager. By way of example, a wager detector 145 may be associated with each player position 140 or may be shared by more than one player. In operation, when a player makes a wager, a player takes tokens from the player's token zone and places them in or on the wager detector 145.

In another embodiment a portable Personal Bet Manager may be provided whereby a player may purchase credits which are registered or stored on the Personal Bet Manager. The Personal Bet Manager includes a user interface whereby the player may then bet the credits that are registered or stored on the Personal Bet Manager, which is available from DEQ Systems Corp. located in Quebec, Canada. The Personal Bet Manager may communicate wirelessly, or via a wired connection, with other components to indicate a player's progressive wager. It is contemplated that the wager detector may be the Personal Bet Manager system.

Additionally, the table 100 may comprise supplement bet spots, token buy-in spots and the like. Optionally, in another embodiment of the table 100, the table's player positions 140 may be configured as card spots and associated card detection zones (not shown). Playing cards may be configured with elements detectable by the card detection zones. Such detection may be by various means including, but not limited to optical and UV scanning and radio wave scanning (better known as radio frequency identification or RFID).

The table may also comprise an optional electronic card reading shoe 174 configured to read the suit and rank of dealt cards. The shoe 174 may communicate with other elements of the table and progressive system. The shoe 174 may also perform card shuffling and present the cards for dealing. A dealer interface 180 is provided and may be connected to the shoe 174 to provide dealer control and to interface with the shoe, such as by providing information regarding cards dealt to the dealer.

The wager detectors 145 and optionally the shoe 174 electrically communicate with a progressive controller 150 that is associated with the table 100. The progressive controller 150 may be disposed, for example, under the table 100, or at a remote location. The shoe 174 or bet detection areas 145 may communicate to the progressive controller 150 to indicate to the progressive controller 150 when a player qualifies for, based on dealt cards, a progressive jackpot or award, and optionally the payout amount based on the cards dealt to the player. This information may be used by the dealer to assist in game play and track progressive participation. The progressive controller 150 records which player positions have placed a progressive wager to allow that player to participate in the progressive. The progressive controller 150 may also time stamp the time of the wager paid by a player or the dealing of cards to a player from the electronic shoe to establish a timing event for the player in relation the wager and secondary game. The controller 150 may also calculate the amount wagered for progressive participation for each table and communicate that to the server 192. Additional tables 151 may also be similarly configured and linked to either the controller 150 or server 192 as shown.

The progressive controller 150 is in communication (wired or wirelessly) with one or more servers 192. The servers 192 may be configured as is known in the art with a processor configured to execute non-transitory machine readable code (software) which is stored in one or more memories. There may be one or more other tables 151, numbered T2 thought TN, where N is any whole number in addition to the table 100. A progressive display 196 also connects to the server 192. The server 192, executing machine readable code, is configured to sum the progressive wagers and display the total possible amount to be won on the progressive display 196. By displaying the large potential progressive payout on the display 196, players are encouraged to play the base game and the progressive. One or more databases 194 are optionally provided to store data, machine readable code, or a combination thereof.

A player may receive cards from a dealer and place them on a player's card position 140. Each player's cards may be detected and monitored by the dealer in an associated card detection zone and the table may be equipped with RFID, overhead, dealer or player active detectors, or other card or token readers. The player positions 140 may also detect or provide space for wagers, such as progressive bets, that are placed and detected with the bet detectors 145. Without limiting the disclosure, it will be appreciated that the table 100 may comprise any number of or combination of player positions 140, detection spots and associated detection zones (bet detectors 145), and the like as discussed above to achieve operation as described herein.

In one example embodiment, the table 100 may comprise a dealer station 160 for a dealer. As is generally understood, the dealer may present the game from the dealer station 160 by dealing cards to players. The dealer station 160 is a location on or in some way associated with the table 100 and/or the dealer on which tokens or playing cards may be placed.

The dealer interface 180 (referred to as DI in FIG. 1) may also be placed near the dealer station 160. The dealer interface 180 comprises a user interface configured to allow the dealer to provide input to the shoe 174 and optionally receive output from the shoe, which can be presented to the dealer and the server 192. In various embodiments, the dealer interface 180 comprises one or more buttons, dials, display screens, LCD/touch screen, lights or other illumination devices, speakers or other audible indicators, or analog dials, potentiometers, or keypads. Through use of the dealer interface 180, the dealer is able to provide input to the shoe 174 or receive data from the shoe 174.

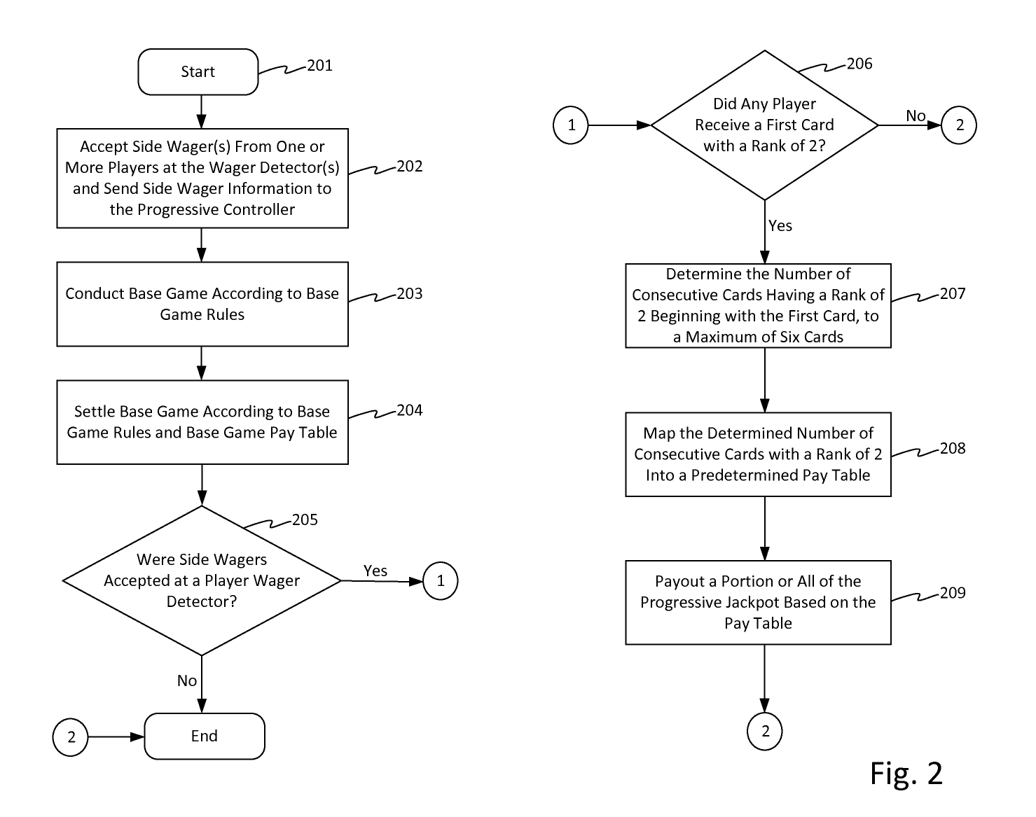

In yet another embodiment, the dealer interface 180 may be configured to communicate with a detection system (discussed above), a player tracking system (as monitored and controlled such as by one or more servers 192) and an accounting system. Other components associated with the dealer interface 180 will be discussed below in the context of both FIGS. 1 and 2.

In FIG. 1 the one or more components may all be integrated into a single device. For example, the dealer interface 180 may be part of the shoe/shuffler 174. In addition, The table may also include a player tracking device, such as a card reader and associated keypad. Such player tracking devices are well known and may permit the game operator to track play of players at the gaming table. The tracked play may be utilized to offer player bonuses or awards.

Servers 192 may additionally have other functions, such as tracking players to provide coupons (also termed “comps”) based on various aspects of players' behaviors. Without limiting the scope of the disclosure, behaviors that may trigger an award of player comps and subsequent printing of player coupons include amounts wagered, won, or lost, number of hands played by the player, or random events, such as a mystery award. Input from a player tracking system may also be utilized. Furthermore, servers 192 may provide accounting and auditing functions during play of a game.

A method for conducting a side wager during a base game will now be explained with reference to FIG. 2. In step 201, a wagering game is initiated, for example, on the gaming table 100. The wagering game in this embodiment is a game of blackjack.

In step 202, in addition to making a base wager or ante in accordance with the base game, players may also make a side wager. The side wager is accepted from the players, for example, via the wager detectors 145, as described above. Information concerning the side wagers is sent from the wager detectors 145 to the progressive controller 150. The progressive controller 150 may send a signal to the dealer interface 180 to inform the dealer of the side wagers made by one or more players. Further, the progressive controller 150 may send wager information to the server 192, which in turn may update the total value of the progressive and to display the total value on a progressive display 196.

Once the side wagers have been accepted, the base game, such as the game of blackjack, proceeds according to the base game rules as shown in step 203. Upon the end of the base game, such as the end of a game of blackjack as described above, the dealer settles the base game in step 204 according to the rules of the base game and any associated base game pay table.

In step 205, when the base game is settled according to the base game's rules and pay table, and if no players submit a side wager, the process ends. However, if one or more players made a side wager for progressive participation, the process continues to step 206.

In step 206, in the present embodiment, it is determined whether any player who made a side wager had a first card with a rank of 2. In other embodiment, other card ranks may be defined as the trigger. The term trigger is defined as a card rank or suit or face type that is designated to initiate the side wager. If none of the players received a first card with the rank of 2 (or defined trigger), then the process ends. If one or more players received a first card with a rank of 2, then the process proceeds to step 207. In other embodiments, the card value (rank) that is required to qualify for the progressive can be a value other than 2. For example, a three card may be required (defined as the trigger) to qualify for or participate in the progressive. In addition, more than one single value may be allowed to qualify for progressive participation as part of the secondary game. For example, any of an ace, 2, or 3 value cards may allow for progressive participation. It is also contemplated that the trigger to qualify for the second wager award may be a black card or a red card, or a particular suit, such as a heart, a pair of cards, such as a pair of kings for the first two cards dealt to a player, or a sequential (straight) run of two cards of any or a particular predefined rank. These various card combination may be defined as a predetermined characteristic, and predetermined subsequent characteristics.

In step 207, it is determined how many consecutive cards with the rank of 2 were received by the player or players having the first card that was ranked 2. In this embodiment, the maximum number of consecutive cards with a rank of 2 that is accepted is six, however, in other embodiments a different number of consecutive cards ranks (such as 2) may be considered or allowed. This may depend in part on the number of decks in the shoe and the underlying rules of the base game, as discussed in more detail below.

The determined number of consecutive cards with a rank of 2 (up to an including six consecutive cards) (or other trigger) are then mapped to a predetermined pay table in step 208. In step 209, a portion or all of the progressive jackpot is paid to the player or players based on the pay table. For example, a player may receive a small award for a single 2 ranked card or two cards with a rank of 2 up to receiving the entire progressive jackpot for receiving the maximum of six consecutive cards (or other predetermined number) with a rank of 2. In other embodiment, a predefined award not linked or sourced from a progressive pool is defined as the award won or earned by the player. The award is then provided to the player, and the progressive award amount is reduced by the amount of the payout. It is also contemplated that the payout may be fixed, such as from a paytable, or linked to a second wager amount, and also that if the top or most desirably outcome is hit, such as a string of six 2's, then the progressive is awarded to the player. When the progressive is awarded to the player, it may be the total amount of the progressive, a portion or percentage of the progressive, or a random amount, which may be bound by an lower and upper limit. It is also contemplated that the award may be a mystery and randomly awarded.

Once the player receives a card that is not a 2 (or other card that is not in accordance with the predefined rules defined by the trigger) then that event ends the accumulation of consecutive cards that contribute to and increase the progressive payout amount.

It is also contemplated that the progressive participation may have different wager amounts to thereby change the number of cards required to win the entire progressive, to determine a percentage of the progressive which is won, or to change the number of different card ranks which may be received as the first card dealt to the player or dealer to allow the player or players to qualify for the progressive. For example, if the player only wagers ½ of the maximum side wager amount, then that player may be entitled to only win ½ of the progressive or other defined award amount, or they may be required to obtain a greater number of cards to qualify for an award.

In addition, the side bet progressive may be based on the dealer's cards or one or more player's cards. For example, in one embodiment, if the dealer receives the one or more consecutive 2's, then the table may share in the progressive, or only the players who placed the side wager may participate. Likewise, if the player receives the 2 as the first card, then only that particular player may participate or all of the players who placed side wagers may participate for the progressive payout.

The method may be utilized on the plurality of tables 151 simultaneously. As described above, each of the tables 151 has a progressive controller 150 connected to the server 192. The server 192 receives the side wager information from each of the tables 151 to calculate the value of the progressive jackpot. The server may then display the value of the progressive jackpot for the tables 151 on the progressive display 196.

In the present embodiment, the above method has the following benefits. First, the side wager as described above will not slow down the play of the base game. As explained above, the payout of the side wager in this embodiment is set according to the number of consecutive cards with the rank of 2. By setting the payout of the side wager to cards with the rank of 2, the player will not change his or her strategy for the underlying game of blackjack, which could cause the player to contemplate, ponder, or adjust game play strategy. If the player is receiving cards with a rank of 2, those players will instinctively continue to request an additional card without delay.

As described above, the object of the base game of blackjack is to obtain a hand totaling a value as close to 21 as possible, without going over. With the side wager as described above, the player has no incentive to depart from the normal strategy of the base game in order to achieve a higher payout award from the progressive. That is, if a player receives up to five consecutive cards with a rank of 2, he or she will have a hand with a value of 10. Because it is not yet possible to go over a value of 21 with the next card, a player in this situation will always hit and receive another card. A player therefore could receive the maximum of six consecutive cards with a rank of two without affecting his or her strategy in the base game of blackjack. Thus, because the player has no incentive to receive “extra” cards to try and obtain the side wager, the speed of the underlying game will not be decreased.

Second, because the player has no incentive to receive “extra” cards, the player will not overly increase his or her chance of busting to win the side wager when the strategy of the underlying game would indicate otherwise. This prevents other players from feeling as though their hand in the blackjack game is ruined or disrupted by a player receiving extra cards only for the sake of a side wager. Further the player requesting cards is not able to ruin their own hand by attempting to win the progressive.

Third, because of the low probability of a player obtaining six consecutive cards with the rank of 2, it is possible for an amount of a progressive jackpot to increase to a very large value. It is, of course, further possible when using multiple decks of cards (which increases the number of 2s in the deck), to base the payout of the progressive jackpot on the suit of the cards as well. Thus, one might pay out the full jackpot when six consecutive cards of the same suit with the rank of 2 are received. In this manner, a progressive jackpot value can be greatly increased due to a payout from the progressive jackpot occurring less often. When the progressive jackpot increases to such a large amount, players may become more likely to play the base game and make side wagers at the thought of the possibility of winning the large progressive jackpot.

Other modifications may be made to the method of conducting a side wager without departing from the scope of the invention. For example, in FIG. 2, the number of consecutive cards with a rank of 2 is determined at the end of a base game. However, the side wager may be tracked in real time. As the cards are received by a player, the shoe 174 may continually update the progressive controller with the identity of the cards received by each player. The progressive controller may then automatically determine the number of consecutive cards with the rank of 2 and payout the progressive jackpot according to the predetermined pay table during the play of the base game. A display on the table may identify winners and jackpot awards for the number of 2s received.

Further, while consecutive cards with a rank of 2 are used in the above embodiment, the invention is not limited to this. The side wager could be based on receiving a consecutive number of cards with a different rank, so long as the play of the underlying base game is unaffected. For example, a full payout of the progressive jackpot may be based on receiving four consecutive cards ranked 3, three consecutive cards ranked 4, or a pair of consecutive cards ranked 5-10 or face cards. Multiple combinations of the above may also be utilized. In this embodiment, consecutive cards ranked 2 are utilized so as to require the largest number of consecutive cards for the highest payout, resulting in a larger progressive jackpot. It is also contemplated that a particular suit of card may also control whether a player may qualify to participate in the progressive or secondary game. For example, the game may be establish to require a black two before a player is qualifies to receive a payout from the progressive jackpot.

In another embodiment, the side wager may be conducted as described above except that a player may choose to accept an award for a certain number of consecutive cards with a rank of 2, or risk losing that award to attempt to receive an additional card ranked to, up to the maximum number of six cards. The reduces the progressive payout occurrence rate, while also providing added excitement for player since the player has to choose whether to keep the progressive sourced award which they have already won, based on the number of consecutive cards with a rank of 2, or risk it for a larger award, subject to receiving an additional card with a rank of 2.

For example, the player station 130 or wager detector 145 may include a “cash out” feature allowing a player to accept the award of a side wager at various points. The cash out feature may comprises a button, lever, touchscreen, or other mechanism to receive input from the player. In this manner, if during the play of a game of blackjack, a player has received three consecutive cards ranked 2, the player can utilize the cash out feature to receive the award for three consecutive cards ranked 2 according to the pay table. However, the player can also continue playing without utilizing the cash out feature in an attempt to receive a higher award for more consecutive cards ranked 2. However, if the next card received by the player is not ranked 2, the player the does not receive any award for the side wager or a reduced portion of the award they might have otherwise received.

The following is an exemplary pay table that may be used with the wagering game described herein.

PAYOUT SCHEDULES

| | | | PAYOUT |
|---|---|---|---|
| HAND | PAYOUT TABLE 1 | PAYOUT TABLE 2 | TABLE 3 |
| Five 2's | 1,000 To 1 + | 1,000 To 1 + | 1,000 To 1 + |
| | Jackpot | Jackpot | Jackpot |
| Four 2's | 200 To 1 | 200 To 1 | 200 To 1 |
| Three 2's | 50 To 1 | 50 To 1 | 50 To 1 |
| Suited Pai | 13 To 1 | 13 To 1 | 15 To 1 |
| Colored Pair | 10 To 1 | 11 To 1 | 10 To 1 |
| Mixed Pair | 10 To 1 | 9 To 1 | 8 To 1 |

The progressive side wager has been described in accordance with a game of blackjack played on a gaming table. However, in another embodiment, the game is presented and played at a gaming machine. Such a gaming machine may have various configurations.

The gaming machine may be located at a casino (and as such is referred to as a “casino gaming machine”). The gaming machine may be part of a gaming system, such as a casino gaming system which links multiple of the gaming machines, one or more table games and other devices such as kiosks, accounting systems or servers, progressive systems or servers, player tracking systems or servers or the like.

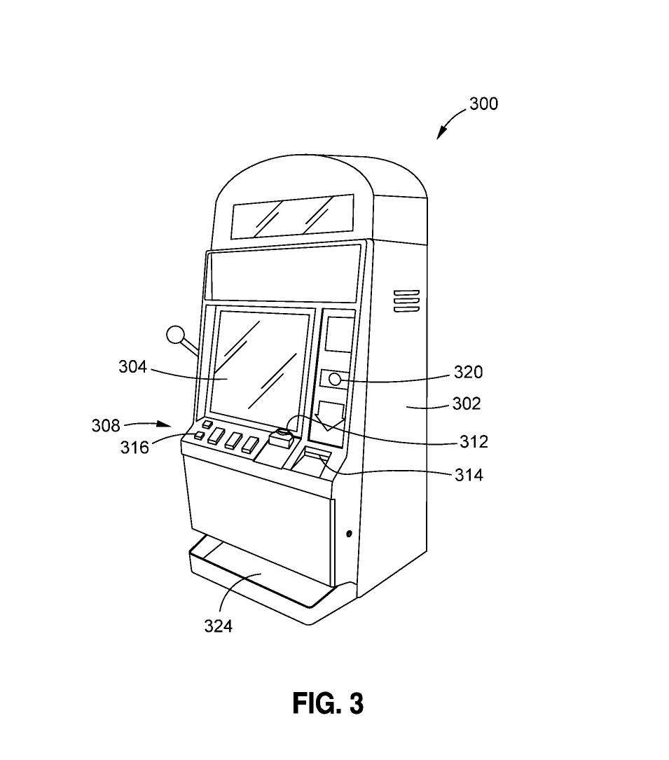

One configuration of a gaming machine 300 is illustrated in FIG. 3. As illustrated, the gaming machine 300 generally comprises a housing or cabinet 302 for supporting and/or enclosing various components required for operation of the gaming machine. In the embodiment illustrated, the housing 302 includes a door located at a front thereof, the door capable of being moved between an open position which allows access to the interior, and a closed position in which access to the interior is generally prevented. The configuration of the gaming machine 300 may vary. In the embodiment illustrated, the gaming machine 300 has an “upright” configuration. However, the gaming machine 300 could have other configurations, shapes or dimensions (such as being of a “slant”-type, “bar-top” or other configuration as is well known to those of skill in the art).

The gaming machine 300 preferably includes at least one display device 304 configured to display game information. The display device 304 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 304 may be capable of projecting or displaying a wide variety of information, including images, symbols and other indicia or information associated with game play, game promotion or other events.

As described in more detail below, the gaming machine 300 is preferably configured to present one or more games upon a player making a monetary payment or wager. In this regard, as described in more detail below, the gaming machine 300 includes means for accepting monetary value.

In one embodiment, as detailed above, certain game outcomes may be designated as winning outcomes. Prizes or awards may be provided for winning outcomes, such as monetary payments (or representations thereof, such as prize of credits), or promotional awards as detailed herein. As detailed below, the gaming machine 300 includes means for returning unused monetary funds and/or dispensing winnings to a player.

The gaming machine 300 preferably includes one or more player input devices 308 (such as input buttons, plunger mechanisms, a touch-screen display, joystick, touch-pad or the like). These one or more devices may be utilized by the player to facilitate game play, such as by providing input or instruction to the gaming machine 300. For example, such input devices 308 may be utilized by a player to place a wager or a side wager, cause the gaming machine 300 to initiate a game, to indicate cards to be held or discarded, to “cash out” of the gaming machine, or to provide various other inputs.

In one preferred embodiment, the gaming machine 300 includes at least one microprocessor or controller for controlling the gaming machine, including receiving player input and sending output signals for controlling the various components of the machine 300 (such as generating game information for display by the display 304). The controller may be arranged to receive information regarding funds provided by a player to the gaming machine, receive input such as a purchase/bet signal when a purchase/bet button 316 is depressed, and receive other inputs from a player. The controller may be arranged to generate information regarding a game, such as generating game information for display by the at least one display 304 (such as information representing images of displayed cards), for determining winning or losing game outcomes and for displaying information regarding awards for winning game outcomes, among other things.

The controller may be configured to execute machine readable code or “software” or otherwise process information, such as obtained from a remote server. Software or other instructions may be stored on a memory or data storage device. The memory may also store other information, such as pay table information. The gaming machine 300 may also include one or more random number generators for generating random numbers, such as for use in selecting cards and for presenting the game in a random fashion.

Preferably, the controller is configured to execute machine readable code or instructions which are configured to implement the method of game play of the invention. For example, the controller of the gaming machine 300 may be configured to detect a wager, such as a signal from a player's depressing of the “bet one” button. Upon such an event and/or the player otherwise signaling the gaming machine to present the game, the controller may be configured to cause cards to be dealt/displayed on the at least one display 304. The controller may accept input from a player of a request to split, buy insurance, obtain additional cards or the like via the one or more player input devices 308 of the gaming machine 300.

The gaming machine 300 may be configured to generate and present games in a stand-alone manner or it may be in communication with one or more external devices at one or more times. For example, the gaming machine 300 may be configured as a server based device and obtain game code or game outcome information from a remote game server (in which event the gaming machine controller may receive game information from the server, such as game outcome information, and use that server-generated information to present the game at the gaming machine).

As indicated, the gaming machine 300 is configured to present one or more wagering games. Thus, the gaming machines 300 is preferably configured to accept value, such as in the form of coins, tokens, paper currency or other elements or devices representing value such as monetary funds. For example, as illustrated in FIG. 3, the gaming machine 300 might include a coin acceptor 312 for accepting coins. Of course, associated coin reading/verifying devices and coin storage devices may be associated with the gaming machine 300 if it is configured to accept coins. Likewise, the gaming machine 300 might include a media reader 314. Such a reader may be configured to accept and read/verify paper currency and/or other media such as tickets. Of course, in such event the gaming machine 300 may further be configured with one or more paper currency or ticket storage devices, such as cash boxes, and other paper currency or media handling devices (including transport devices).

The gaming machine 300 might also be configured to read FOBs, magnetic stripe cards or other media having data associated therewith and via which value or funds may be associated with the gaming machine 300.

In one embodiment, the gaming machine 300 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. For example, upon an award or at cash-out, associated funds may be paid to the player by the gaming machine 300 dispensing coins to a coin tray 324. In another embodiment, funds may be issued by dispensing paper currency. In yet another embodiment, a player may be issued a media, such as a printed ticket, which ticket represents the value which was paid or cashed out of the machine.

The gaming machine 300 may also include a player tracking device, such as a card reader and associated keypad 320. Such player tracking devices are well known and may permit the game operator to track play of players of the gaming machine. The tracked play may be utilized to offer player bonuses or awards.

It will be appreciated that the gaming machine illustrated in FIG. 3 is only exemplary of one embodiment of a gaming machine. For example, it is possible to for the gaming machine to have various other configurations, including different shapes and styles and having different components than as just described.

For example, it is possible for the base game and side wager to be presented on a computing device, including at a home or office computer, a kiosk or other types of devices. For example, the game and side wager might be presented via an application running on a computing device, or in a server-based or “Internet” environment. In one embodiment, a player might log in to a casino server and the controller of the casino server may cause game information to be delivered to the player's computer and then be displayed on a display of the player's computer. In this regard, it will be noted that the term “controller” may comprise more than one device. For example, in a server-based environment, a controller at a server may generate game information and transmit that information to a local controller at a gaming machine. The local controller at the gaming machine may then cause game information to be displayed on the display of the gaming machine. The games of the invention could also be presented by or at hand-held devices, such as PDAs, cellular phones, tablet computing devices or the like.

A casino may have numerous such gaming machines 300, such as located on a casino floor or in other locations. Of course, such gaming machines 300 might be used in other environments, such as an airport, a bar or tavern or other locations.

The side wager may also be presented one or more gaming devices 300 as described above while being simultaneously presented to players at gaming tables 151. The display 304 of the gaming device may show the amount of the progressive jackpot similar to the progressive display 196.

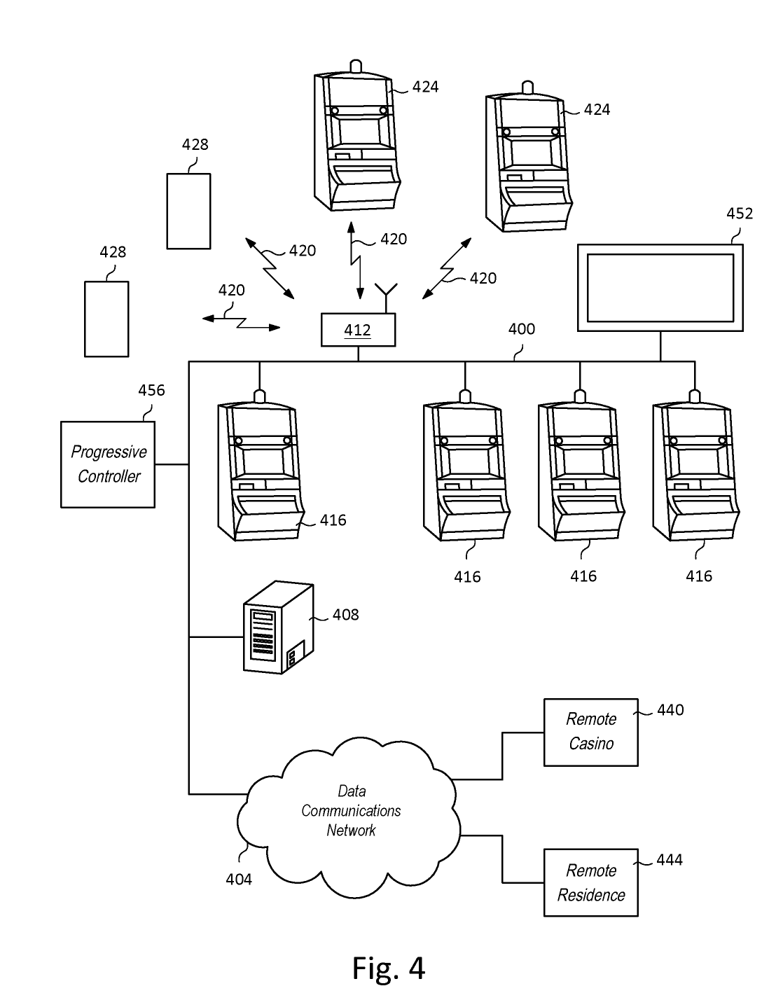

FIG. 4 is a block diagram of an example gaming system with a server based network. The communications network 400, 404 connects to multiple devices as discussed below to enable communication between devices. The network 400, 404 may be any type network capable of exchanging data between devices. The network may include a local network 400 and an external network 404 such as for example the Internet, or an Intranet with appropriate security mechanisms. The wagering game network may include other network devices, such as one or more servers which may comprise accounting servers, wide area progressive servers, player tracking servers, game content servers, or any other type server.

In this embodiment the gaming establishment at the top of the figure includes a network 400. As shown, the gaming network includes gaming machines 416 connected to the network 400 via a wired connection.

The network 400 may include a wireless device 412 capable of communicating over a wireless link 420 with one or more wireless gaming machines 424 or hand held gaming devices 428 A wagering game server 408 may serve wagering games on the gaming machines over the local area network 400 and function as a remote controller for the wagering games as described above.

The wagering network includes hardware and memory storing machine readable instructions and machine readable code for performing the operations described herein. Those of ordinary skill in the art will appreciate that each gaming establishment may include additional local area networks such which may serve to connect many other wagering games. Alternatively, multiple servers 408 may be used for the functions of the wagering game server which provide game content to the gaming machines 416, 424, 428.

The local area network 206 may be any type of suitable property LAN configuration including, for example, a dedicated hardwired property LAN or a wireless property LAN. The local area network 206 may be configured in any configuration or topology.

The local area network includes wired communication links 400 and wireless communication links 420. In this example configuration, the stand-alone gaming machines 416 communicate with the network 402, 408 via the wired communication links as shown. The stand-alone gaming machines 428 as well as the handheld gaming devices 428 communicate with the network 400, 408 via the wireless communication links 420. One or more wireless communication devices 412, with associated antennas, enables wireless communication. Other combinations of wired and wireless connections to different gaming machines may be used. The wired and wireless communication links may employ any suitable connection protocols such as Bluetooth, IEEE 802.11, Ethernet, or any other format or standard. The network 400, 408 may be configured to enable downloading of instruction sets (software) for games, game configuration data, game outcomes, from the central server(s) such as the server 408 to the gaming machines, and to enable uploading or downloading of marketing and operations data from the gaming terminals to the central server.

As shown at the bottom of FIG. 4, the game server 408 or network 400 may also serve wagering game devices and/or distribute content to devices located in other gaming establishment 440 or at other locations 444 such as a residence.

The server 408 may be any type computer capable of executing programs or instruction sets for controlling gaming machine, such as slot machines, video slots, or video poker machines, and communication with wireless devices. Although shown as a single server, numerous servers may be used. In such embodiments, the gaming machines 416, 424, 428 may each be a simple input/output terminal with regard to the functions controlled by the server 408. For example, the random selection of outcomes for the basic game and any bonus game may be functions performed by the server 408 and subsequently provided to a gaming machine. Functions that are not provided by the server 408, such as control of the local lights, sounds, and displays of the gaming machine, are handled by the local CPU within the gaming machine.

In this embodiment, a progressive or accumulated jackpot system is provided that includes a video or other type display 452 that is coupled to the network 400, 408. The display 452 is viewable by a number of players to present a total jackpot that is available for award upon receipt of a predetermined outcome. This type event may be referred to as community based events accessible from games on the gaming machines or from remote locations 440, 444 or gaming devices 428. For example, the display 452 may be used to show a current progressive jackpot or jackpots which players playing different gaming machines may be eligible to win. The display 452 may be any type display.

In one embodiment, the community event is a progressive award or jackpot, which is preferably linked with other gaming machines via the network 400, 408 and/or the network 204. The entire progressive award or jackpot may be won upon the occurrence of a certain outcome of the game. In other embodiment, the award is not fixed but instead the size of the award or jackpot is random such that when an award is triggered an RNG or other mechanism generates a random value which determines the amount, size, or type of prize. The prize or award may be monetary or a tangible item or service.

The server 408 may also operate one or more progressive awards concurrently with the basic game and/or bonus games. As explained above, such progressive awards are funded by appropriating a percentage of the coin-in from participating gaming machines. To be eligible to win the progressive award, the player may be required to make a progressive award side wager or make a wager satisfying predetermined criteria, e.g., a maximum wager or a wager covering all available paylines in the basic game. Then, upon occurrence of jackpot-won event in the form of either a “mystery” event or one or more predetermined outcomes in the basic game and/or bonus game, the player is awarded the progressive jackpot in addition to any regular prize or award resulting from the basic game and/or bonus game. The jackpot-won event may, for example, be the appearance of a predetermined scatter symbol during the basic game. A basic game menu may be part of the game disclosed herein and include several options for a player, including picking games, progressive options, and side bet options. Other community events may include a community bonus game, a bonus prize shared by multiple players, a multiplier award or other community features. Such a community event may interrupt the game play on the gaming machine and use other mechanisms such as the display 452 to show graphics or video relating to the community event. In this example embodiment, each one of the players who are currently playing wagering games on the gaming machines participates in the community event according to an eligibility criteria such as time-based eligibility that each gaming machine determines locally. In this example, a community event or progressive controller 456 associated with the display 452 and progressive system continuously runs a process to determine if the community bonus should occur, using its random number generator (RNG) and monitor coin-in or wagers to increment the amount on the display. For example, controller 456 determines if the community event is triggered. If the controller 465 determines that the community event is triggered or won, then it will issue an invitation to the gaming machines. Because each of the wagering games on the gaming machines keeps track of the current eligibility of the respective games being played, each of the gaming machines makes a decision whether it will allow the player to participate in the community event, and at which multiplier any bonuses or prizes resulting from the community event will be awarded to the player. It is to be understood that a server such as the server 408 or a master gaming machine may be used for the controller 456.

The server 408 includes a storage device that contains software instruction sets for different wagering games which may be loaded onto a memory of gaming machines. It is to be understood that different parts of the instruction sets may be stored on the memory with other parts of the instruction sets stored on the individual gaming machines. For example, the gaming machines may store part of the instruction sets in the form of modules relating to graphics files, audio/sound files, and certain game functions and operations such as player greetings or instructions. The stored instructions sets are mated with the remainder of the instruction sets loaded from the memory over the network 400.

Part or all of the software instruction set for wagering games may be sent to the various gaming machines via the wired communication links 400 or the wireless communication links 420. The wagering games may be stand alone or may offer eligibility or access to progressive awards or support other community events with other gaming machines on the network 400 or external networks 404.

The server 408 in this example stores a number of wagering games in the storage device. It is to be understood that part of the software to support the wagering games may already reside on the system memory of the gaming machine. For example, the modules responsible for RNG, audio and/or video drivers, etc. may reside on the system memory of the gaming machine. Other components of the instruction set of the game such as graphics files, audio files etc. may also reside in the storage device. Some or all of the instruction set may be loaded via the external I/O circuit from the network 400 such as from the storage device of the server 408. In this manner, the gaming machine may be used to play different games without requiring manual delivery of instruction sets different games to the gaming machine.

For example, a player may request a certain wagering game based on an initial display of a menu of wagering games displayed by the gaming machine. The menu may include some or all available wagering games stored on the server 408. Other background graphics and/or videos may be displayed on the primary display or the secondary display of the gaming machine to attract players to the gaming machine. The secondary display may be electronic or a secondary game to present a secondary game outcome. Based on the menu display 400, a player may select the desired game via a player input device such as the push buttons or touch screen buttons. Further, an operator of the casino may use the server to load wagering games to different gaming machines based on popularity, location, time interval, special events, schedule, etc.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A method of presenting a game at a gaming table equipped with or communicating with a progressive controller and one or more wager detectors, the method comprising the steps of:
providing at least one physical deck of at least 52 playing cards at the playing table equipped with or communicating with the progressive controller;
accepting a first wager from a player to participate in a blackjack game;
accepting a second wager from the player, the second wager qualifying the player to participate in a secondary game;
detecting the second wager with the one or more wager detectors, the wager detector generating a secondary game wager signal;
receiving the secondary game wager signal at the progressive controller and incrementing a progressive jackpot by an amount of the second wager or a portion of the amount of the second wager;
displaying an incremented progressive jackpot amount on a progressive display;
presenting the blackjack game including dealing cards to form a player hand and a house hand, the player hand including a first dealt player card and one or more subsequently dealt player cards that are dealt to the player after the first dealt player card;
determining an outcome of the blackjack game;
when the outcome of the blackjack game is a winning outcome, awarding a blackjack game award to the player;
determining if the first dealt player card has a rank of two;
when the first dealt player card has the rank of two, determining a number of consecutive subsequently dealt player cards that also have the rank of two to determine a number of consecutive two-ranked cards;
comparing the a number of consecutive two-ranked cards to a paytable, the paytable defining an award amount or portion of a progressive jackpot award based on the number of consecutive two-ranked cards;
responsive to the comparison, providing a payout from the progressive jackpot to the player.

2. The method according to claim 1, wherein a maximum number of consecutive two-ranked cards is six.

3. The method according to claim 2, wherein the entire progressive jackpot is paid when the number of consecutive two-ranked cards is six.

4. The method according to claim 2, wherein a portion of the progressive jackpot, but not all, is paid when the number of consecutive two-ranked cards is between 1 and 5.

5. The method according to claim 1, wherein the progressive linked between multiple tables at one or more casinos.

6. A method of presenting a secondary award to players at a gaming table, the method comprising:
providing at least one physical deck of playing cards at the a gaming table, the gaming table being communicatively coupled to a progressive jackpot controller;
accepting a first wager from a player to participate in a base wagering game at the one or more gaming tables;
accepting a second wager from the player, the second wager qualifying the player to potentially receive a second award;
presenting the base wagering game including dealing the playing cards to form a hand of cards, the hand including a first dealt card and one or more subsequently dealt cards that are dealt after the first dealt card;
determining an outcome of the base wagering game;
when the outcome of the base wagering game is a winning outcome, awarding a game award to the player;
determining if the first dealt player card has a predetermined characteristic;
when the first dealt player card has the predetermined characteristic, determining a number of consecutive subsequently dealt cards that have predetermined subsequent characteristics;
comparing the first dealt player card and the subsequently dealt player cards that have predetermined subsequent characteristics to a paytable, the paytable defining an award amount or percentage of a progressive jackpot based on characteristics of the first and subsequent death player cards;
responsive to the comparison, providing a payout to the player.

7. The method according to claim 6, wherein the predetermined characteristic and the predetermined subsequent characteristics for the player dealt cards do not alter a strategy in the base wagering game.

8. The method according to claim 7, wherein the base wagering game is a blackjack game.

9. The method according to claim 8, wherein the predetermined characteristic and the predetermined subsequent characteristics define cards in which a sum of the rank is less than or equal to ten.

10. The method according to claim 8, wherein the predetermined characteristic and the predetermined subsequent characteristics define consecutive cards having a rank of two, and a maximum number of the consecutive cards having the rank of two is six.

11. The method according to claim 8, wherein the predetermined characteristic and the predetermined subsequent characteristics define consecutive cards having a rank of three, and a maximum number of the consecutive cards having the rank of three is four.

12. The method according to claim 8, wherein the predetermined characteristic and the predetermined subsequent characteristics define consecutive cards having a rank of four, and a maximum number of the consecutive cards having the rank of four is three.

13. The method according to claim 8, wherein the predetermined characteristic and the predetermined subsequent characteristics define consecutive cards comprising a straight with a lowest ranked card of two, and a longest straight being consecutive cards comprising the ranks of two, three, four, and five.

14. The method according to claim 6, wherein the comparing step is continually performed during the presenting of the base wagering game.

15. A system for presenting an award to a player, the system comprising:
a progressive jackpot controller comprising a processor and at least one memory storing machine readable instructions;
a progressive jackpot display communicatively coupled to the progressive jackpot controller; and
at least one gaming device comprising at least one wagering accepting device that accepts a wager from a player participating in the progressive jackpot, the at least one gaming device being configured to present a base wagering game separate from the progressive jackpot, and being communicatively coupled to the progressive jackpot controller;
the wagering accepting device accepting a first wager from a player to participate in a base wagering game at the gaming device and accepting a second wager or a portion of the first wager from the player qualifying the player to participate in the progressive jackpot;
the progressive jackpot controller receiving a second wager signal generated by the wagering accepting device and incrementing the progressive jackpot by an amount of the second wager or a portion of the amount of the second wager;
the progressive jackpot display presenting an incremented progressive jackpot amount;
a base wagering game being presented via the gaming device, the base wagering game including dealing the playing cards to form a hand of cards, the hand including a first dealt card and one or more subsequently dealt cards that are dealt after the first dealt card, and the gaming device sending identification information for the first dealt card and the subsequently dealt cards to the progressive jackpot controller;
the progressive jackpot controller determining if the first dealt card has a predetermined rank;
when the first dealt player card has the predetermined rank, the progressive jackpot controller determining a number of consecutive subsequently dealt cards conforming to one or more predetermined winning patterns;
the progressive jackpot controller comparing the subsequently dealt cards conforming to one or more predetermined winning patterns to a paytable, the paytable defining a progressive jackpot award amount based on the one or more predetermined winning patterns;
responsive to the comparison, the progressive jackpot controller providing a payout from the progressive jackpot to the player.

16. The system according to claim 15, wherein the base wagering game comprises blackjack.

17. The system according to claim 15, wherein the predetermined winning patterns do not alter a strategy for receiving the subsequently dealt cards in the base wagering game.

18. The system according to claim 14, wherein the hand of cards is at least one of a player hand and a dealer hand.

19. A method of presenting a game at a gaming table comprising:
providing at least one physical deck of at least 52 playing cards at the physical game table;
accepting a first wager from a player to participate in a blackjack game;
accepting a second wager from the player, the second wager qualifying the player to participate in a secondary game;
presenting the blackjack game including dealing cards to form a player hand and a house hand, the player hand including a first dealt player card and one or more subsequently dealt player cards that are dealt to the player after the first dealt player card;
determining an outcome of the blackjack game;
when the outcome of the blackjack game is a winning outcome, awarding a blackjack game award to the player;
determining if the first dealt player card has a predetermined characteristic;
when the first dealt player card has the predetermined characteristic, determining a number of consecutive subsequently dealt player cards that have the subsequent card predetermined characteristics to determine a second game outcome;
comparing the second game outcome to a paytable, the paytable defining an award amount or an award percentage of a progressive jackpot for the second game outcome; and
responsive to the comparison, providing a payout to the player when the second game outcome is a winning second game outcome.

20. The method of claim 19, wherein the predetermined characteristic is a rank of 2.

21. The method of claim 19, wherein the predetermined characteristic for the first dealt player card is not the same as the predetermined characteristics for subsequently dealt player cards.
